(19) United States
(12) Patent Application Publication
(10) Pub. No.: US 2007/0025100 A1
(43) Pub. Date: Feb. 1, 2007

(54) Sport safe LED helmet

(76) Inventor: Amy Kristina Caruana, Windsor, CA (US)

Correspondence Address: AMY CARUANA, UNIT 308, 1885 WESTVIEW PARK BLVD., WINDSOR, ON, N9H 2R8, CA

(21) Appl. No.: 11/477,960

(22) Filed: Jun. 30, 2006

(30) Foreign Application Priority Data
Mar. 11, 2005 (CA) 2,500,147

(51) Int. Cl. F21V 21/084; F21V 23/04

(52) U.S. Cl. 362/105; 362/394

(57) ABSTRACT

The invention provides an improved helmet for safety. The helmet includes a circuit of LED lights (light emitting diodes) that illuminate around the outer edge of the helmet. The lights are affixed to the outer edge of the helmet with the wire contained between the outer casing of the helmet and a plastic edging. The plastic edging has spaces where the lights are visible. The light circuitry encompasses the entire helmet edge. The wires of the circuit extend into the helmet straps. The light circuit is activated when the helmet strap clasp is connected. The power source for the circuit is a battery. The battery is encased in a plastic casing. The battery source is affixed on the posterior, lower edge of the helmet. The construction of the helmet is not altered to accommodate this design. This invention provides an improved safety helmet, more particularly of the type commonly called bike or ski helmet.

### CROSS-REFERENCE TO RELATED APPLICATIONS

Prior application has been made in Canada, application number 2,500,147 and filing date of March 11, 2005. According to Patent Law Section 35 U.S.C. 119 the original filing date of March 11, 2006 cannot be applied as the filing date for this application as it is being filed beyond one year. The inventor was unaware of such a law but was directed by the Canadian Patent Office which had referred to the United States Patent Office on the law that it would still be possible to attain a patent in the United States as the Canadian patent had not been made public and would not be made public until September, 2006. In addition, according to the Patent Law Section 35 U.S.C. 119 (b) (2) “The director may consider the failure of the applicant to file a timely claim for priority as a waiver of any such claim. The Director may establish procedures, including the payment of a surcharge, to accept an unintentionally delayed claim under this section”. A copy of the Patent Certificate has been included with this application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Helmets have long been known and widely used. Helmet light apparatus have been patented as both exterior devices and within the construction of the helmet. External light battery operated devices have been developed ranging form a single light design to complete fiber optic design. Typical light systems for helmets of this type are shown, for example, in the following Canadian patents:

CA 1213256 Romulus

CA 2227042 Howie

CA 2340526 Fischer et al

Though such helmet light designs may have assisted with safety issues, the law now requires helmet use for all ages. This design will encourage children and adults to strap their helmets on properly so the lights will be on. This design will also assist skiers to be visualized by other skiers at night or in heavy snow conditions.

### SUMMARY OF THE INVENTION

Considered broadly, helmets are safety devices that vary in shape and size. This LED system according to the invention is adaptable to a variety of helmet styles. The LED circuit is activated at the connection that is located within the strap clasps. Once the connection is made the lights are activated that are located on the peripheral edge of the helmet. The lights are a variety of bright colors that blink to achieve a high level of visual alertness to observers. The power source is encased with a plastic case. The encased power source is located on the posterior edge of the helmet.

In the drawings, which form a part of this specification,

FIG. 1 is a side view of the left side of the helmet with the LED circuit contained within. The LED circuit wires are seen in the straps in this left side view only with the female connector in the strap clasp.

FIG. 1 is a side view of the right side of the helmet of FIG. 1 with the male connector shown in the strap clasp;

FIG. 2 is a side view of the right side of the helmet of FIG. 1 with the male connector shown in the strap clasp;

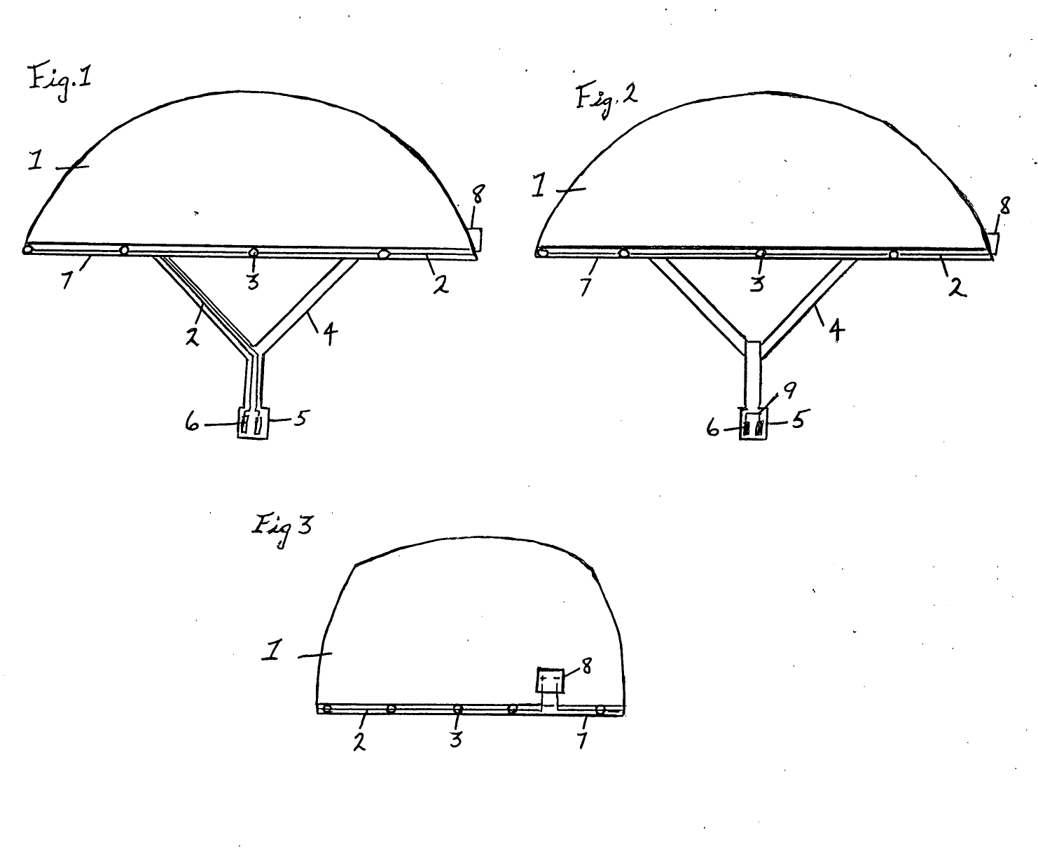

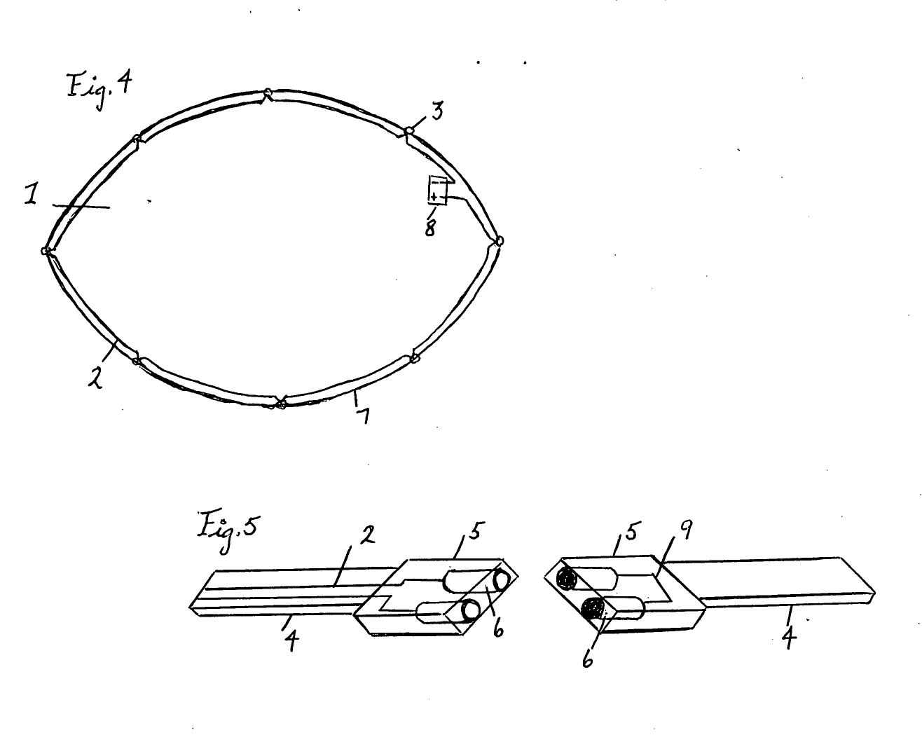

FIG. 3 is a rear view of the helmet of FIGS. 1 and 2. The LED circuit is visible in addition to the battery encasement;

FIG. 4 is a top view of the helmet of FIGS. 1, 2 and 3. The LED circuit and battery encasement are visible.

FIG. 5 is an enlarged view of the strap and clasp of FIGS. 1 and 2. The left strap is shown to contain the LED circuit wires with a female connector in the clasp. The right side clasp contains the male connector pins and jumper wire.

### DETAILED DESCRIPTION ON THE INVENTION

In the particularly advantageous embodiment of the invention, the LED circuit connection that activates the illumination of the lights is comprised of;

The LED circuit is encased along the periphery of the helmet edge by the plastic beading 7 with circular spaces for the light to be exposed as seen in FIG. 1.

The electrical circuit itself is comprised of 24 gauge wire 2, light emitting diodes 3, a connector of male and female pins 6 and jumper wire 9 and a 9-volt battery power source as seen in FIG. 1.

The LED circuit is affixed to the helmet 1 by the molding 7, within the strap 4, the circuit wire 2 extends down into the strap clasp 5.

As best seen in FIG. 3, the battery assembly is encased in a plastic case 8. The battery power source is comprised of a 9 volt battery.

In a sport safe LED helmet, the combination of the bright light peripheral circuitry, the strap clasp LED circuit activation and the power source portions have claims as follows:

1. An LED electrical circuit comprising an activation connection within the clasps of the helmet straps.

2. An LED electrical circuit that is encased within a plastic molding around the periphery of the helmet with spaces that expose the lights and within the straps of the helmet to the clasps.

3. Wherein the power source is encased in a plastic case, connected to the circuit and affixed to the rear edge of the helmet.

4. An LED activation connection as defined in claim 1, in which the clasp must be engaged for the activation of the light to occur.

5. The strap clasp activation site of claim 1 is comprised of male connector pins of the right strap clasp that insert into the female connectors of the left strap clasp.

6. An LED electrical circuit as defined in claim 2, in which the 24-gauge wire connects light emitting diodes, a 9-volt power source and male and female connectors of claim.

7. A power source as defined in claim 3, which is comprised of a 9-volt battery encased in a plastic case.

8. An LED electrical circuit system as defined in claim 2, of which is encased in a plastic molding of the peripheral edge of the helmet and the straps.
